(19) United States
(12) Patent Application Publication
(10) Pub. No.: US 2017/0153645 A1
(43) Pub. Date: Jun. 1, 2017

(54) VEHICLE STOP GUIDANCE SYSTEM AND VEHICLE STOP GUIDANCE METHOD

(71) Applicant: Mitsubishi Electric Corporation, Tokyo (JP)

(72) Inventor: Takahisa AOYAGI, Tokyo (JP)

(73) Assignee: Mitsubishi Electric Corporation, Tokyo (JP)

(21) Appl. No.: 15/166,535

(22) Filed: May 27, 2016

(30) Foreign Application Priority Data
Nov. 26, 2015 (JP) 2015-230506

(51) Int. Cl. G05D 1/02; B60K 35/00

(52) U.S. Cl. CPC G05D 1/0246; G05D 1/0255; G05D 1/0257; B60K 35/00; B60K 2350/106; G05D 2201/0213

(57) ABSTRACT

A vehicle stop guidance system and a method for storing a camera image obtained from a camera device configured to photograph a surrounding of a set vehicle to be stopped into a camera image storage unit; detecting a target facility at which the set vehicle is to be stopped; calculating a distance between a target object being a target which exists at the target facility and for which the set vehicle is to be stopped and a target device of the set vehicle to be made closer to the target object; calculating a stop position that causes the distance between the target object and the target device to fall within a set range based on a calculation result of the distance; and guiding the set vehicle to the stop position based on a calculation result of the position.

### BACKGROUND OF THE INVENTION

1. Field of the Invention

The present invention relates to a vehicle stop guidance system and a vehicle stop guidance method for controlling a vehicle to be guided to a fuel dispenser at a gas station or a ticket vending machine or a payment machine at a parking lot.

2. Description of the Related Art

In recent years, an unmanned system utilizing machines has become mainstream at a gas station, a gate of a parking lot, and a gate of an expressway in order to reduce labor costs. Hitherto, at the gas station, an employee for the gas station guides an entering vehicle to a stop position so that a position of a fuel port of a driver's own vehicle optimally matches a position of a fuel supply nozzle, to thereby allow the driver thereof to stop his or her vehicle without paying attention to the stop position.

However, with the rise of self-service gas stations, the driver is now required to determine the stop position by himself or herself. This raises a problem in that the driver may stop the vehicle to find the position of the fuel port of the own vehicle to be far from the position of the fuel supply nozzle, which inhibits the nozzle from reaching the fuel port, or to be too close, which makes fueling difficult. There is another problem in that, for example, the driver may stop the vehicle to erroneously match the stop position to the place of a fuel dispenser located on the opposite side of the fuel port of the vehicle.

Also at the gate of the parking lot or the expressway, a worker has helped the driver so as to match the stop position of the driver's own car to the gate by, for example, reaching out the worker's hand to the driver so far. However, the unmanned system now requires the driver himself or herself to stop the car so as to match the stop position to the position of the ticket vending machine or the payment machine, which raises a problem of, for example, causing the driver's time and labor for stopping the vehicle so as to match the stop position to target equipment.

In view of the above-mentioned problems, in Japanese Patent Application Laid-open No. 07-117639 and Japanese Patent Application Laid-open No. 11-292198, new equipment is introduced in the gas station to solve the problems by enabling the fueling without troubling the driver. However, in those related-art examples, the new equipment that requires a huge cost needs to be introduced in addition to the existing equipment of the gas station, which raises a problem in that the introduction of the new equipment in facilities existing nationwide causes a huge amount of cost and is hard to realize.

On the other hand, each automobile manufacturer's interest in a preventive safety function of an automobile has recently been rising, and the share of vehicles mounted with a plurality of cameras, sensors, and radars has recently been increasing against the entire vehicles.

### SUMMARY OF THE INVENTION

The present invention has been made in order to solve the above-mentioned problems, and has an object to provide a vehicle stop guidance system and a vehicle stop guidance method for causing a vehicle to be guided to and stopped in a desired position by effectively using an existing system mounted on the vehicle to suppress a cost required for the introduction of a new system to a minimum.

According to one embodiment of the present invention, there is provided a vehicle stop guidance system, including: a camera device configured to photograph a surrounding of a set vehicle to be stopped; a camera image acquisition unit configured to store a camera image obtained from the camera device into a camera image storage unit; a target facility detection unit configured to detect a target facility at which the set vehicle is to be stopped; a target object distance calculation unit configured to calculate a distance between a target object being a target which exists at the target facility and for which the set vehicle is to be stopped and a target device of the set vehicle to be made closer to the target object; a stop position calculation unit configured to calculate a stop position that causes the distance between the target object and the target device to fall within a set range based on a calculation result from the target object distance calculation unit; and a stop position guidance unit configured to guide the set vehicle to the stop position based on a calculation result from the stop position calculation unit.

According to one embodiment of the present invention, it is possible to realize the vehicle stop guidance system and the vehicle stop guidance method that suppress the cost, through use of advanced driver assistance systems (ADAS systems) that have already been mounted, by eliminating the need for new equipment in a target facility and by also making it unnecessary or keeping it to a minimum to add a new device to the vehicle.

### BRIEF DESCRIPTION OF THE DRAWINGS

FIG. 1 is a diagram for illustrating a configuration of a vehicle stop guidance system according to one embodiment of the present invention.

FIG. 2 is an operation flowchart of an entire system of FIG. 1.

FIG. 3 is operation flowcharts of examples of target facility detection processing conducted by a target facility detection unit of FIG. 1.

FIG. 4 is an operation flowchart of an example of target object distance calculation processing conducted by a target object distance calculation unit of FIG. 1.

FIG. 5 is an operation flowchart of an example of stop position calculation processing conducted by a stop position calculation unit of FIG. 1.

FIG. 6 is an operation flowchart of an example of stop position guidance processing conducted by a stop position guidance unit of FIG. 1.

FIG. 7 is a diagram for illustrating the target object distance calculation processing, the stop position calculation processing, and the stop position guidance processing that are conducted by the vehicle stop guidance system according to the present invention.

FIG. 8 is a diagram for illustrating an example of what is displayed on a monitor of a car navigation device in the stop position guidance processing conducted by the vehicle stop guidance system according to the present invention.

FIG. 9 is a diagram for illustrating another example of the target object distance calculation processing, the stop position calculation processing, and the stop position guidance processing that are conducted by the vehicle stop guidance system according to the present invention.

FIG. 10 is a diagram for illustrating an example of a specific configuration of a control unit of FIG. 1.

### DETAILED DESCRIPTION OF THE PREFERRED EMBODIMENTS

Referring to the accompanying drawings, a vehicle stop guidance system and a vehicle stop guidance method according to embodiments of the present invention are described below. Note that, in each of the embodiments, the same or corresponding elements are denoted by the same reference symbols and a redundant description is omitted.

Further, in the following description, when a “target facility” at which a vehicle is to be stopped is, for example, a gas station, a “target object” represents a fuel dispenser or a fuel supply nozzle of the gas station, and a “target device” represents a fuel port of a target vehicle to be subjected to vehicle stop guidance.

Further, when the “target facility” is an automatic toll gate of a parking lot, a toll gate of an expressway, or the like, the “target object” represents a ticket vending machine or a payment machine, and the “target device” represents a door to a driver's seat of the target vehicle to be subjected to the vehicle stop guidance.

### First Embodiment

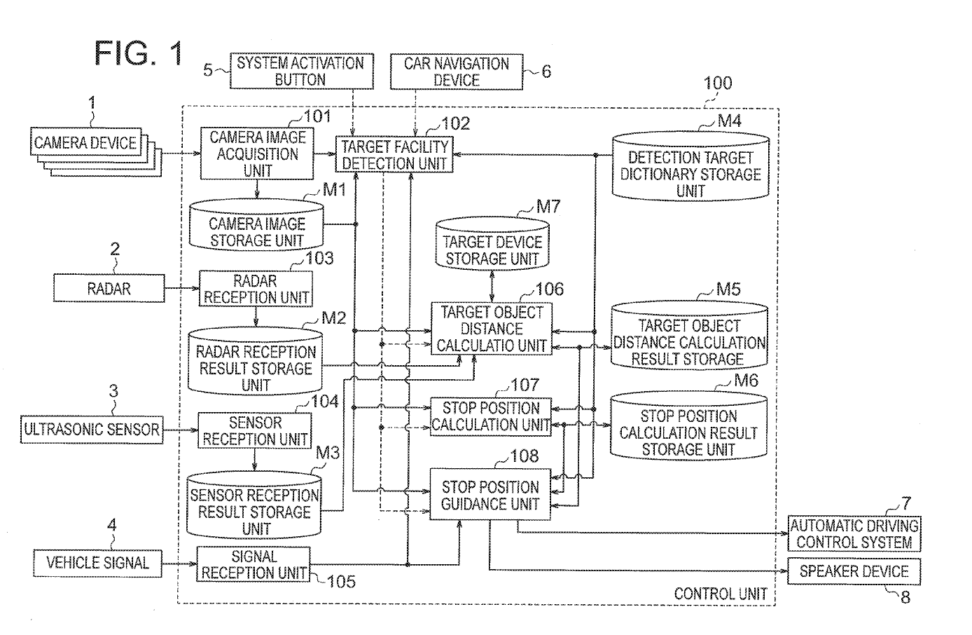

FIG. 1 is a diagram for illustrating a configuration of a vehicle stop guidance system according to one embodiment of the present invention. As an example, the vehicle stop guidance system illustrated in FIG. 1 is mounted on one vehicle. A control unit 100 indicated by the broken line is formed of, for example, a processor including a memory, and conducts control in cooperation with respective devices and signals illustrated outside the control unit 100.

At least one camera device 1 photographs and monitors the surroundings of the vehicle to be stopped.

A camera image acquisition unit 101 stores a camera image obtained from the camera device 1 into a camera image storage unit M1. Note that, calculation accuracy for a distance improves through use of the camera image obtained from the camera device 1 provided near the fuel port or the door to the driver's seat being the target device.

A target facility detection unit 102 detects the target facility from the camera image stored in the camera image storage unit M1, the signal received from a system activation button 5 operated by the user who is to activate the system, or point of interest (POI) information mainly indicating facility information on the surroundings of the own vehicle obtained from a car navigation device 6.

A detection target dictionary storage unit M4 stores in advance feature points of the target facility, images of the target object of the target facility, images of a vehicle stop frame pattern and a vehicle stop bar pattern for the target object described later included in the target object, and the like. The feature points of the target facility are, for example, images of signboards of the gas station and the automatic toll gate.

A target object distance calculation unit 106 calculates a distance between the target object of the target facility and the target device of the own vehicle.

A stop position calculation unit 107 calculates and determines a stop position that causes the distance between the target object and the target device to fall within an optimal set range based on the above-mentioned calculation result of the distance.

A target object distance calculation result storage unit M5 stores the calculation result of the distance between the target object of the target facility and the target device of the own vehicle.

A stop position calculation result storage unit M6 stores the calculation result of the stop position.

A target device storage unit M7 stores the image of the target device of the target vehicle, which is formed of the fuel port, the door to the driver's seat, or the like of the target vehicle, namely, the own vehicle in this case.

A vehicle signal 4 is a signal indicating a traveling state or the like of the vehicle received from another control device or the like of the own vehicle.

A signal reception unit 105 receives the vehicle signal 4.

A stop position guidance unit 108 guides the own vehicle to the stop position based on the above-mentioned calculation result and vehicle information acquired from the signal reception unit 105.

Then, based on a guidance result from the stop position guidance unit 108, an automatic driving control device 7 conducts automatic driving, a speaker device 8 informs of the guidance by voice guidance or electronic sound, and the car navigation device 6 displays the guidance.

In order to increase the calculation accuracy of the target object distance calculation unit 106, the vehicle stop guidance system further includes a radar 2, a radar reception unit 103, a radar reception result storage unit M2, an ultrasonic sensor 3, a sensor reception unit 104, and a sensor reception result storage unit M3. The target object distance calculation unit 106 can improve the calculation accuracy by using the detection signals received from the radar 2 and the ultrasonic sensor 3.

As the above-mentioned respective devices used for the system according to the present invention, a surround view camera, an engine control unit (ECU) for controlling a surround view monitor, a system on chip (SOC), a car navigation system, speakers, a radar, an ultrasonic sensor, and the like that have already been mounted on the vehicle can be used as well.

Note that, when the control unit 100 is formed of one processor, a processor 100a substantially has such a configuration as illustrated in, for example, FIG. 10 as a known technology. Input and output are conducted from/to the outside through an interface (I/F) 10a, and a CPU 10b conducts arithmetic processing for various kinds of control based on programs and data necessary for control processing stored in a memory 10c and based on data, signals, and the like received from the outside, outputs the processing result to the outside, and records the data in the memory 10c as the need arises. In the control unit 100 of FIG. 1, the respective pieces of processing executed based on the above-mentioned programs are illustrated as functional blocks. The respective storage units M1 to M7 of FIG. 1 are formed of the memory 10c.

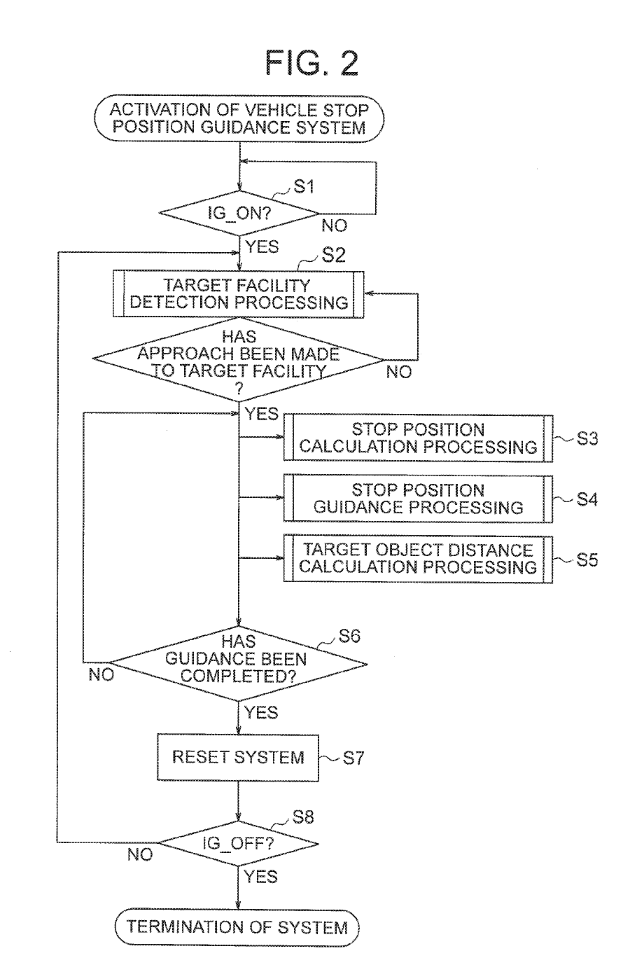

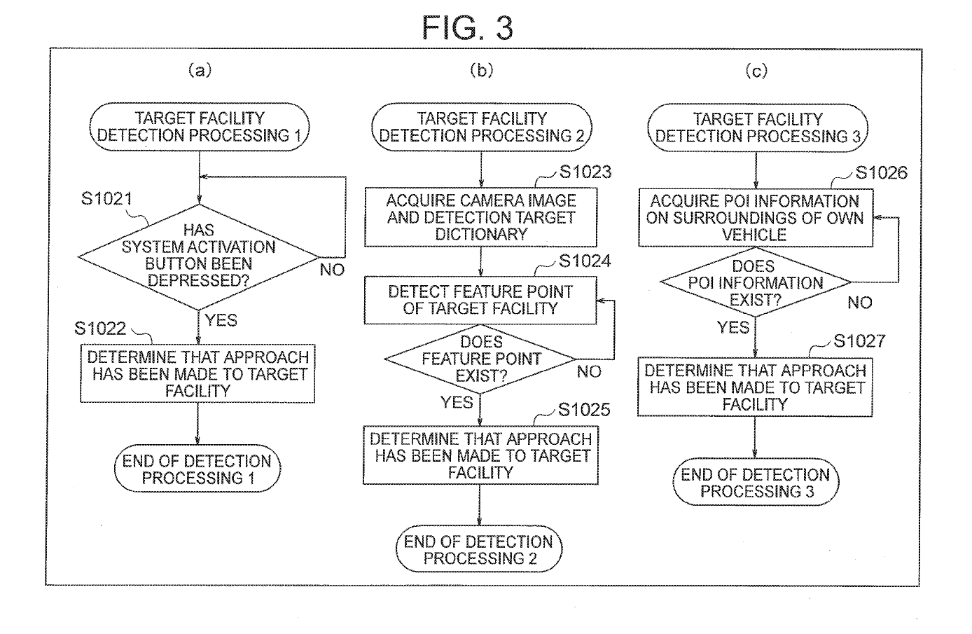

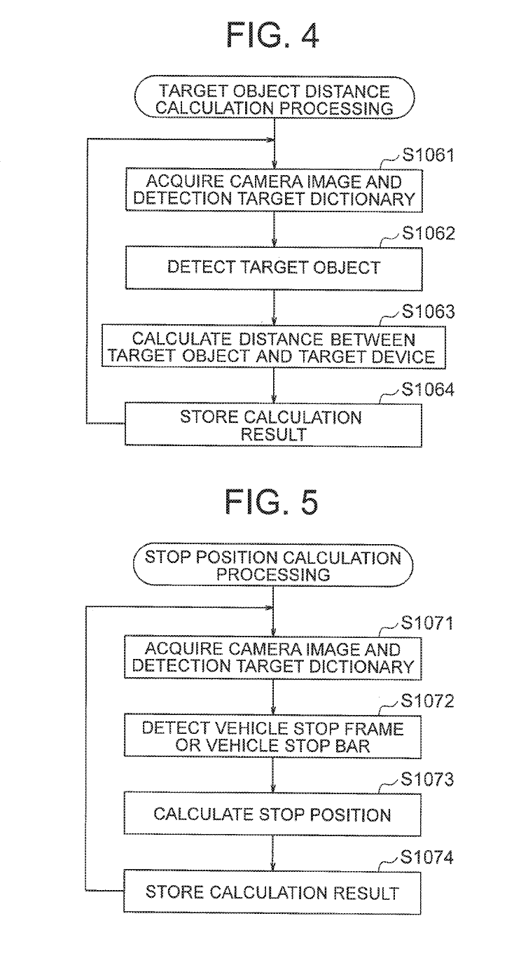

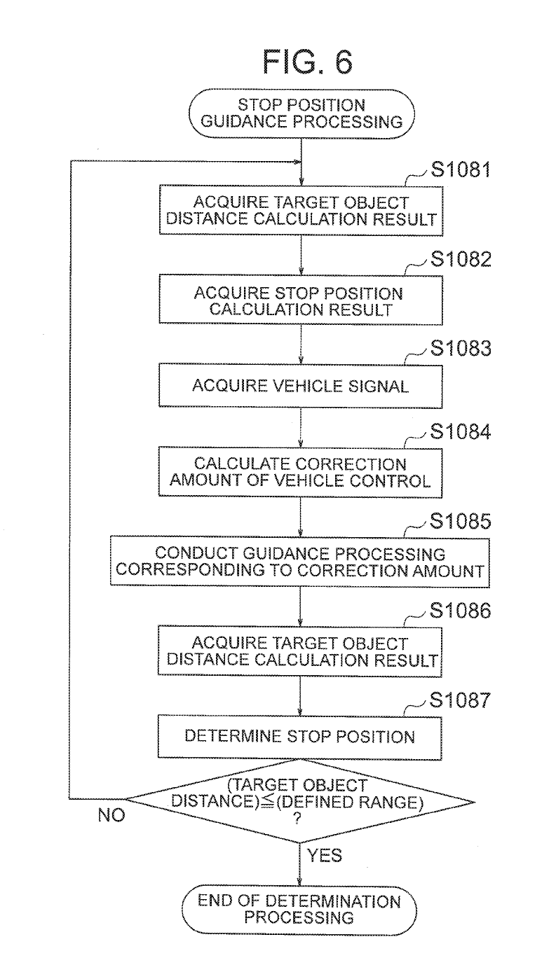

Next, operations are described with reference to operation flowcharts illustrated in FIG. 2, FIG. 3, FIG. 4, FIG. 5, and FIG. 6. FIG. 2 is an operation flowchart of an entire system of FIG. 1. When the ignition (IG) of the vehicle is turned on (Step S1), target facility detection processing is conducted by the target facility detection unit 102 (Step S2). When the own vehicle being the target vehicle moves and approaches the target facility to detect the target facility, stop position calculation processing (Step S3) to be conducted by the stop position calculation unit 107, stop position guidance processing (Step S4) to be conducted by the stop position guidance unit 108, and target object distance calculation processing (Step S5) to be conducted by the target object distance calculation unit 106 are activated.

When the own vehicle comes to an optimal stop position, the guidance is determined to have been completed (Step S6), and the system is reset (Step S7). Then, the above-mentioned processing is repeatedly conducted until the ignition (IG) is turned off (Step S8).

As flows (a) to (c) of FIG. 3, operation flowcharts of examples of the target facility detection processing conducted by the target facility detection unit 102 in Step S2 of FIG. 2 are illustrated. In the flow (a), the target facility detection unit 102 determines that approach has been made to the target facility based on the operation of the system activation button 5. For example, when dropping by the gas station, the user or driver (hereinafter referred to roughly as “user”) depresses the system activation button 5 before heading to the fuel dispenser (Step S1021). The target facility detection unit 102 determines that approach has been made to the target facility based on an activation signal generated by the depression of the system activation button 5 (Step S1022).

In the flow (b) of FIG. 3, the target facility detection unit 102 detects the feature point of the target facility from the camera image within the camera image storage unit M1 for storing the camera image acquired by the camera device 1, and determines presence or absence of the target facility based on a detection result thereof and a change in the vehicle signal 4. For example, the signboard of the gas station is set as the feature point, and the feature point of the signboard of the gas station is stored in advance in the detection target dictionary storage unit M4. When the user drops by the gas station, the target facility detection unit 102 determines that approach has been made to the target facility based on the signboard of the gas station being the feature point included in the camera image stored in the camera image storage unit M1 and the vehicle signal 4 indicating that the vehicle has left the road and entered the gas station. That is, the camera image is acquired from the camera image storage unit M1 or the camera device 1, and the feature point of the target facility is acquired from the detection target dictionary storage unit M4 (Step S1023). It is determined whether or not the feature point of the target facility is included in the camera image (Step S1024), and as further need arises, the traveling state as to, for example, whether the vehicle has turned right or left toward the feature point is determined from the vehicle signal 4 indicating the traveling state of the vehicle, to thereby determine that approach has been made to the target facility (Step S1025).

In the flow (c) of FIG. 3, the target facility detection unit 102 determines the presence or absence of the target facility based on the POI information obtained from the car navigation device 6. For example, when the user drops by the gas station, the POI information on the target facility can be acquired from information on the surroundings of the own vehicle, and when it is determined from the vehicle signal 4 that the own vehicle has left the driveway in the position of the target facility (Step S1026), it is determined that approach has been made to the target facility (Step S1027).

When it is determined that approach has been made to the target facility in the target facility detection processing conducted by the target facility detection unit 102 illustrated in the flows (a) to (c) of FIG. 3, the target facility detection unit 102 issues an activation notification to the stop position calculation unit 107 for conducting the stop position calculation processing (Step S3), the stop position guidance unit 108 for conducting the stop position guidance processing (Step S4), and the target object distance calculation unit 106 for conducting the target object distance calculation processing (Step S5).

FIG. 4 is an operation flowchart for illustrating an example of the target object distance calculation processing conducted by the target object distance calculation unit 106 in Step S5 of FIG. 2. In FIG. 4, when the activation notification is issued from the target facility detection unit 102, the target object distance calculation unit 106 acquires the camera image stored in the camera image storage unit M1 and information on the target facility stored in the detection target dictionary storage unit M4 (Step S1061). Then, the target object of the target facility stored in the detection target dictionary storage unit M4 is detected from the camera image stored in the camera image storage unit M1 (Step S1062). Then, the distance between the target object of the target facility and the target device of the own vehicle stored in the target device storage unit M7 is calculated (Step S1063), and the calculation result is stored into the target object distance calculation result storage unit M5 (Step S1064).

For example, when the user drops by the gas station, based on the image of the target object formed of the fuel dispenser or the fuel supply nozzle stored in the detection target dictionary storage unit M4, the fuel dispenser or the fuel supply nozzle within the camera image is detected from the camera image stored in the camera image storage unit M1. Further, the target device of the target vehicle of the user formed of the fuel port of the target vehicle stored in the target device storage unit M7 is detected from the same camera image. Then, the distance between the detected fuel supply nozzle being the target object and the fuel port being the target device of the target vehicle of the user is calculated, and the calculation result is stored into the target object distance calculation result storage unit M5.

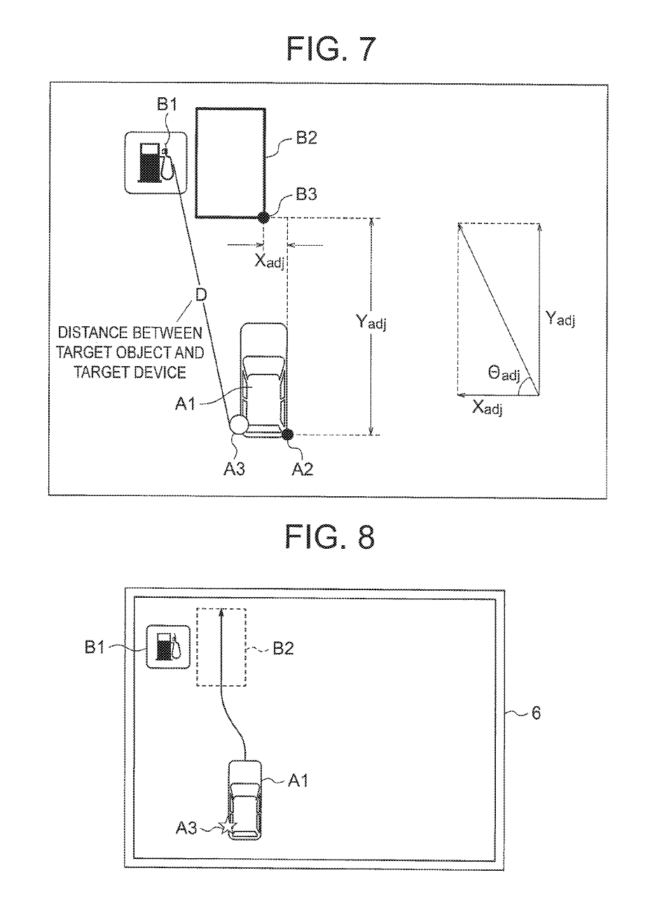

In FIG. 7, an example of calculating the distance between the fuel dispenser being the target object and the fuel port being the target device is illustrated. In FIG. 7, A1 represents the own vehicle being the target vehicle, A2 represents an own vehicle reference point of the own vehicle, A3 represents the fuel port being the target device of the own vehicle, B1 represents the fuel dispenser or the fuel supply nozzle being the target object of the target facility, B2 represents a vehicle stop frame for the fuel dispenser or the fuel supply nozzle, and B3 represents a vehicle stop frame reference point.

In FIG. 7, D represents a linear distance between the fuel dispenser being the target object and the fuel port being the target device, which is indicated by the term “distance between target object and target device”, and it is implied that the value of D becomes smaller as the own vehicle becomes closer to the fuel dispenser. The target object distance calculation unit 106 repeatedly conducts the detection of the target object including the detection of the target device, the calculation of the distance between the target object and the target device, and the storing of the calculation result, and constantly keeps storing the most recent calculation result into the target object distance calculation result storage unit M5.

FIG. 5 is an operation flowchart for illustrating an example of the stop position calculation processing conducted by the stop position calculation unit 107 in Step S3 of FIG. 2. In FIG. 5, when the activation notification is issued from the target facility detection unit 102, the stop position calculation unit 107 acquires the camera image stored in the camera image storage unit M1 and information on the target object stored in the detection target dictionary storage unit M4 (Step S1071). Then, the image of the vehicle stop frame or a vehicle stop bar that matches the vehicle stop frame pattern or the vehicle stop bar pattern for the target object of the target facility stored in the detection target dictionary storage unit M4 is detected from the camera image stored in the camera image storage unit M1 (Step S1072). Then, the stop position is calculated from the vehicle stop frame or the vehicle stop bar for the target object of the target facility and the target device of the own vehicle stored in the target device storage unit M7 (Step S1073), and the calculation result is stored into the stop position calculation result storage unit M6 (Step S1074).

For example, when the user drops by the gas station, based on the image of the vehicle stop frame pattern of the target object stored in the detection target dictionary storage unit M4, the vehicle stop frame within the camera image is detected from the camera image stored in the camera image storage unit M1. Then, a distance between a preset reference point of the detected vehicle stop frame and a reference point of the target vehicle of the user is calculated, and the calculation result is stored into the stop position calculation result storage unit M6.

Therefore, the stop position is obtained based on the vehicle stop frame or the vehicle stop bar, to thereby calculate the stop position that causes the distance between the target object and the target device to fall within a set range.

Note that, when the vehicle stop frame or the vehicle stop bar for the target object does not exist, for example, a point defined by distances from the target object respectively set in advance in the X-axis and the Y-axis within a horizontal plane relative to the target object is set as a stop position reference, and the stop position is calculated based on the stop position reference. The respective distances from the target object in the X-axis and the Y-axis within the horizontal plane for the stop position reference is stored in advance in the detection target dictionary storage unit M4.

In FIG. 7, an example of calculating a distance between the vehicle stop frame reference point B3 of the vehicle stop frame B2 and the own vehicle reference point A2 of the target vehicle is also illustrated. In FIG. 7, the vehicle stop frame reference point B3 and the own vehicle reference point A2 are each set on the rear right, but do not always need to be set on the rear right, and any reference point that indicates a positional relationship between the vehicle stop frame B2 and the own vehicle A1 may be set. Further, the calculated stop position is expressed by vector values (Xadj,Yadj) in the X-axis corresponding to a horizontal direction and the Y-axis corresponding to a depth direction when viewed forward from the own vehicle within the horizontal plane extending from the own vehicle reference point A2 to the vehicle stop frame reference point B3, and indicates that the vector values (Xadj,Yadj) have smaller values as the own vehicle becomes closer to the stop position. In the stop position calculation processing, the detection of the vehicle stop frame, the calculation of the stop position, and the storing of the calculation result are repeatedly conducted, to thereby constantly keep storing the most recent calculation result into the stop position calculation result storage unit M6.

FIG. 6 is an operation flowchart for illustrating an example of the stop position guidance processing conducted by the stop position guidance unit 108 in Step S4 of FIG. 2. In FIG. 6, the stop position guidance unit 108 acquires a target object distance calculation result obtained by the target object distance calculation unit 106 and stored in the target object distance calculation result storage unit M5, a stop position calculation result obtained by the stop position calculation unit 107 and stored in the stop position calculation result storage unit M6, and the vehicle signal 4 (Steps S1081 to S1083), and calculates therefrom a correction amount of how much control of the own vehicle is remaining to be done (Step S1084). Then, guidance processing corresponding to the correction amount is conducted (Step S1085). Then, the target object distance calculation result is acquired (Step S1086), and the processing is repeatedly conducted until a target object distance falls within a defined range being the second set range (Step S1087).

In FIG. 8, an example of the guidance processing conducted by the stop position guidance unit 108 is illustrated. An example of what is displayed on a monitor of the car navigation device 6 or the like of the own vehicle is illustrated. The arrow is displayed in association with the vector values (Xadj,Yadj) in the X-axis and the Y-axis from the own vehicle reference point A2 to the vehicle stop frame reference point B3 illustrated in FIG. 7, which can visually comprehensively display how the user should control the vehicle hereafter.

In FIG. 8, the guidance conducted by display is illustrated, but the guidance may be conducted by a method other than display. For example, the speaker device 8 may be used to audibly comprehensively guide how the user should control the vehicle hereafter through use of voice guidance or electronic sound. In addition, based on the vector values (Xadj,Yadj) in the X-axis and the Y-axis from the own vehicle reference point A2 to the vehicle stop frame reference point B3, an instruction may be sent to the automatic driving control device 7 to cause the own vehicle to be automatically guided and driven to the set stop position.

In this manner, in this embodiment, an example of using the camera device 1 is illustrated, but the calculation accuracy of the radar 2 and the calculation accuracy for the target object distance can also be improved through use of the radar 2, the radar reception unit 103, the radar reception result storage unit M2, the ultrasonic sensor 3, the sensor reception unit 104, and the sensor reception result storage unit M3 that are included to improve the calculation accuracy of the target object distance calculation unit 106.

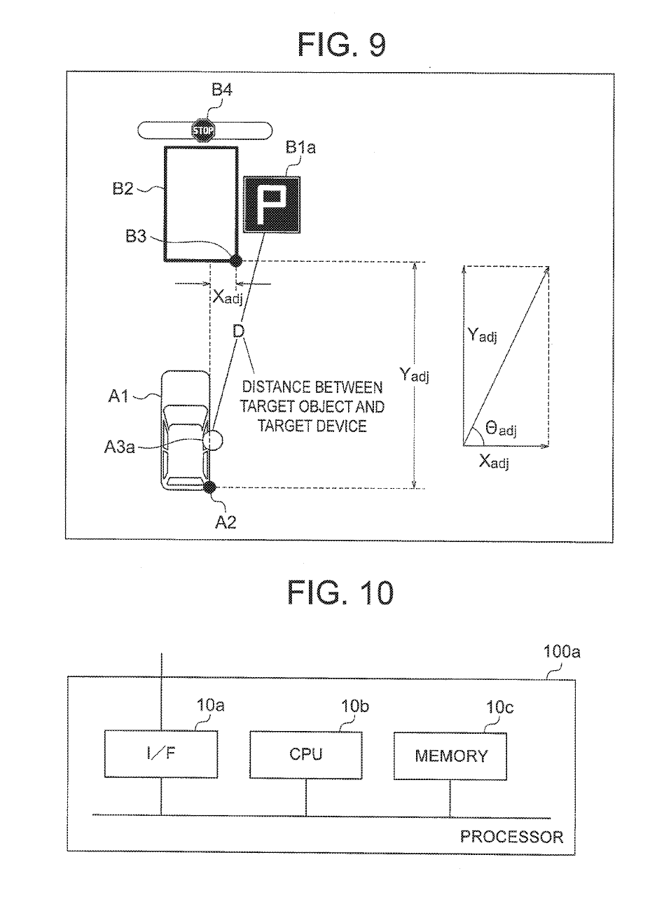

Further, in the above-mentioned embodiment, the guidance to the gas station is described, but the target facility can be applied not only to the gas station but also to the automatic toll gate at a gate of the parking lot, the expressway, or the like. In this case, the target object is the ticket vending machine or the payment machine. In FIG. 9, an example at the parking lot, the expressway, or the like is illustrated, and the specific operation is the same as described above in the case of the gas station. B4 represents a vehicle stop bar, B1a represents the ticket vending machine or the payment machine, and A3a represents the door to the driver's seat.

Further, in the above-mentioned embodiment, the target vehicle is described as the own vehicle mounted with the vehicle stop guidance system according to the present invention, but the present invention is not limited thereto, and vehicle stop guidance control can also be conducted for a vehicle that is not mounted with the vehicle stop guidance system as the target vehicle. In this case, the control unit 100 of FIG. 1 and the various devices illustrated around the control unit 100 are connected to each other through wireless communications as the need arises.

As described above, in the vehicle stop guidance system and the vehicle stop guidance method according to the present invention, the system that has already been mounted is effectively used, to thereby be able to suppress a cost required for the introduction of a new system to a minimum.

What is claimed is:

1. A vehicle stop guidance system, comprising:
a camera device configured to photograph a surrounding of a set vehicle to be stopped;
a camera image acquisition unit configured to store a camera image obtained from the camera device into a camera image storage unit;
a target facility detection unit configured to detect a target facility at which the set vehicle is to be stopped;
a target object distance calculation unit configured to calculate a distance between a target object being a target which exists at the target facility and for which the set vehicle is to be stopped and a target device of the set vehicle to be made closer to the target object;
a stop position calculation unit configured to calculate a stop position that causes the distance between the target object and the target device to fall within a set range based on a calculation result from the target object distance calculation unit; and
a stop position guidance unit configured to guide the set vehicle to the stop position based on a calculation result from the stop position calculation unit.

2. The vehicle stop guidance system according to claim 1, wherein the camera image obtained from the camera device arranged near the target device is used.

3. The vehicle stop guidance system according to claim 1, wherein the target facility detection unit is configured to start detecting the target facility based on at least one of image recognition of the camera image obtained from the camera device, POI information obtained from a car navigation device, or an activation signal obtained from a system activation button to be operated by a user.

4. The vehicle stop guidance system according to claim 2, wherein the target facility detection unit is configured to start detecting the target facility based on at least one of image recognition of the camera image obtained from the camera device, POI information obtained from a car navigation device, or an activation signal obtained from a system activation button to be operated by a user.

5. The vehicle stop guidance system according to claim 1, wherein the target object distance calculation unit is configured to calculate the distance between the target object and the target device based on the camera image obtained from the camera device.

6. The vehicle stop guidance system according to claim 2, wherein the target object distance calculation unit is configured to calculate the distance between the target object and the target device based on the camera image obtained from the camera device.

7. The vehicle stop guidance system according to claim 3, wherein the target object distance calculation unit is configured to calculate the distance between the target object and the target device based on the camera image obtained from the camera device.

8. The vehicle stop guidance system according to claim 4, wherein the target object distance calculation unit is configured to calculate the distance between the target object and the target device based on the camera image obtained from the camera device.

9. The vehicle stop guidance system according to claim 1, wherein the target object distance calculation unit is configured to calculate the distance between the target object and the target device based on a detection signal received from at least one of a radar or an ultrasonic sensor.

10. The vehicle stop guidance system according to claim 1, wherein the stop position calculation unit is configured to calculate the stop position by detecting at least one of the target object, a vehicle stop frame for the target object, or a vehicle stop bar for the target object from the camera image obtained from the camera device.

11. The vehicle stop guidance system according to claim 1, wherein the stop position guidance unit is configured to guide the set vehicle to the stop position through use of at least one of: one of voice guidance and electronic sound output by a speaker device; a monitor screen output by a car navigation device; or a control signal to be sent to the automatic driving control device of the set vehicle.

12. The vehicle stop guidance system according to claim 1, wherein:
the target facility comprises a gas station;
the target object comprises one of a fuel dispenser and a fuel supply nozzle; and
the target device comprises a fuel port of the set vehicle.

13. The vehicle stop guidance system according to claim 1, wherein:
the target facility comprises an automatic toll gate;
the target object comprises one of a ticket vending machine and a fuel supply nozzle payment machine; and
the target device comprises a door to a driver's seat of the set vehicle.

14. A vehicle stop guidance method, comprising:
storing a camera image obtained from a camera device configured to photograph a surrounding of a set vehicle to be stopped into a camera image storage unit;
detecting a target facility at which the set vehicle is to be stopped;
calculating a distance between a target object being a target which exists at the target facility and for which the set vehicle is to be stopped and a target device of the set vehicle to be made closer to the target object;
calculating a stop position that causes the distance between the target object and the target device to fall within a set range based on a calculation result of the distance; and
guiding the set vehicle to the stop position based on a calculation result of the position.
